(19) United States
(12) Patent Application Publication
(10) Pub. No.: US 2008/0315024 A1
(43) Pub. Date: Dec. 25, 2008

(54) Composite Spacer Strip Material

(76) Inventor: Raymond G. Gallagher, Pittsburgh, PA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/997,357

(22) PCT Filed: Jul. 21, 2006
(86) PCT No.: PCT/EP06/07211

§ 371 Date: Jul. 7, 2008

Related U.S. Application Data
(60) Provisional application No. 60/704,509, filed on Aug. 1, 2005.

(51) Int. Cl. B32B 27/00; B65H 55/00

(52) U.S. Cl. 242/159; 428/411.1

(57) ABSTRACT

A composite spacer strip material for manufacturing spacers for window units, comprises a first layer made of an elastically-plastically deformable material, preferably a plastic material, and at least one second layer made of a plastically deformable material, preferably metal or curable matrix or a composite layer or a multi-layer material, which at least one second layer is materially connected to the first layer to form the composite spacer strip material, which composite spacer strip material extends in a longitudinal direction with a predetermined width in a width direction perpendicular to the longitudinal direction and a predetermined thickness in a thickness direction perpendicular to the longitudinal and width directions, wherein the first layer extends over the complete width in the width direction, and wherein the at least one second layer extends over at least a part of the width in the width direction.

The present invention relates to a composite strip material, which can be preferably used for manufacturing spacers, in particular spacers for insulating glass units (hereinafter IG units).

As most participants and observers of the window industry in North America know, Intercept IG units are a significant component in the fenestration manufacturing process. Understandably, the IG spacer is a principal element of any IG construction, and the Intercept technology for spacer manufacturing has had a major impact on IG unit economics and quality for over ten years. The spacer making process involves using a strip of material, usually tin-plated steel as shown in a cross sectional view in FIG. 14, and rollforming the strip into a U-shaped spacer. Typically, the strip material is supplied to the IG unit fabricator on a large spool or coil in a strip width designated for a particular spacer width size. It is not unusual for a IG unit manufacturer to have several coils of different strip widths on-hand. After the spacer forming process, a desiccated matrix material is extruded into the channel. In a cost sensitive industry such as window making, the Intercept process has proven to be a very competitive, low cost process for IG unit fabrication. Notably, Glass Equipment Development Incorporated of Twinsburg, Ohio is an equipment supplier for this particular spacer making process. Over the years, a few variations of strip material selection have occurred. However, even today, the basic material for spacers is still 0.010″ (2.54×10⁻⁴ m) thick, tin-plated steel.

With regard to the thermal performance behavior of tin-plated steel and other spacer materials, testing results have been well documented over ten years. Edge conductivity tests show the tin-plated steel spacer to be “warm edge technology”, and much better than the aluminium box spacer.

It is the object of this invention to provide a more competitive spacer material with regard to thermal performance and material costs, while still preserving favorable fabrication process economics.

This object is achieved by composite spacer strip material according to claim 1.

Further developments of the invention are given in the dependent claims.

It should be noted this concept of a composite strip for use in fabricating spacers is not limited to the Intercept IG spacer approach, but the strip could be used in a wide variety of spacer designs and shapes.

The composite spacer strip material is beneficiary, for example, because
the strip material can be roll-formed on a conventional Intercept production line or other spacer making equipment,
a spacer manufactured from the new strip material provides enhanced thermal performance for an IG unit and window,
the strip material can be made available in various strip widths, and
the strip material is lower or equivalent in cost to stainless steel and complex composite spacers.

Further features and advantages of the invention will become apparent from the following description of embodiments, referring to the drawings, which show cross sectional views perpendicular to the longitudinal direction of the spacer strip material as follows:

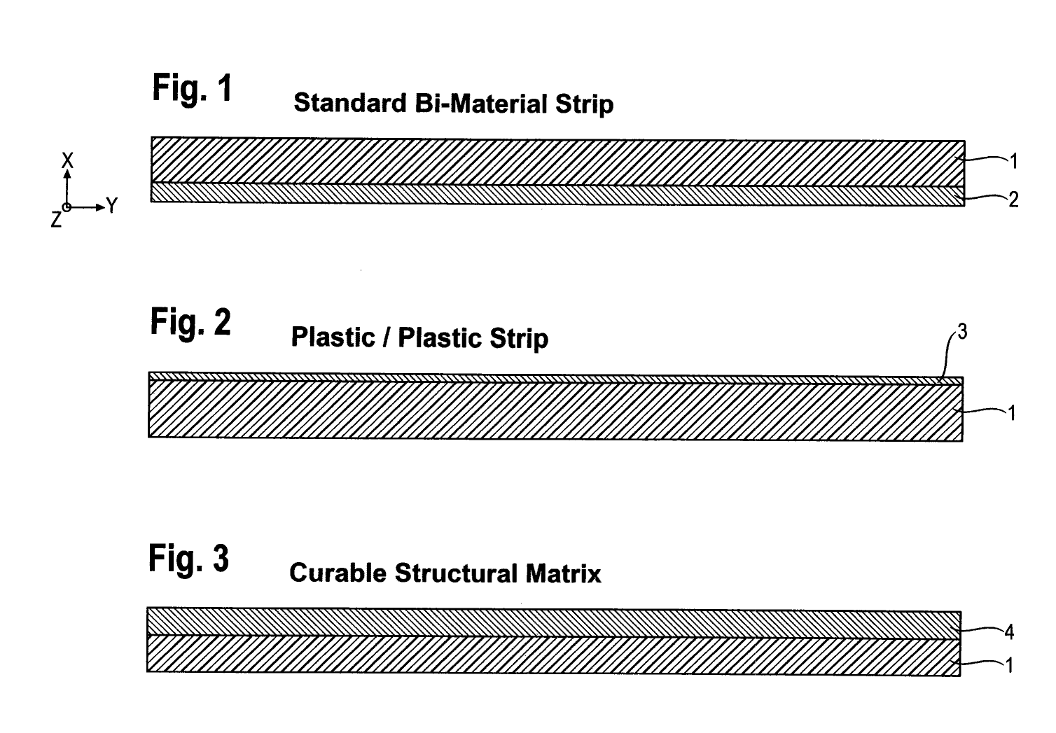

FIG. 1 a composite spacer strip material made of plastic and stainless steel according to a first embodiment;

FIG. 2 a composite spacer strip material made of plastic and multi-layer tape according to a second embodiment;

FIG. 3 a composite spacer strip material made of plastic and a curable matrix according to a third embodiment;

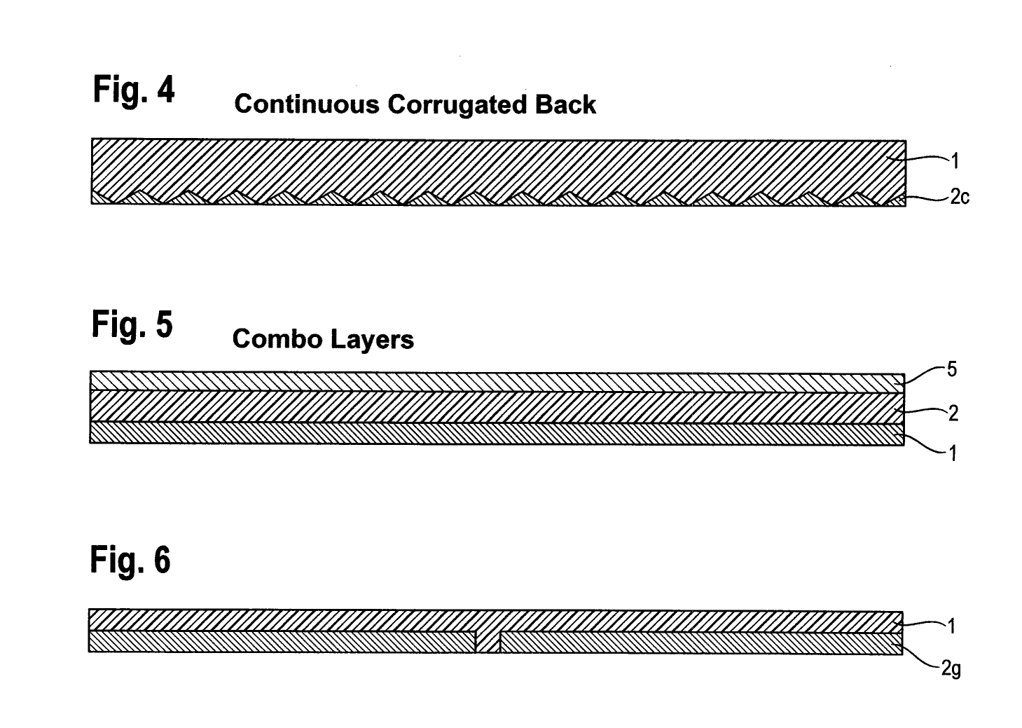

FIG. 4 a composite spacer strip material made of plastic and a corrugated metal sheet according to a fourth embodiment;

FIG. 5 a composite spacer strip material made of a plastic layer and embedded between a matrix layer and a metal layer according to a fifth embodiment;

FIG. 6 a composite spacer strip material made of plastic and metal layers according to a sixth embodiment;

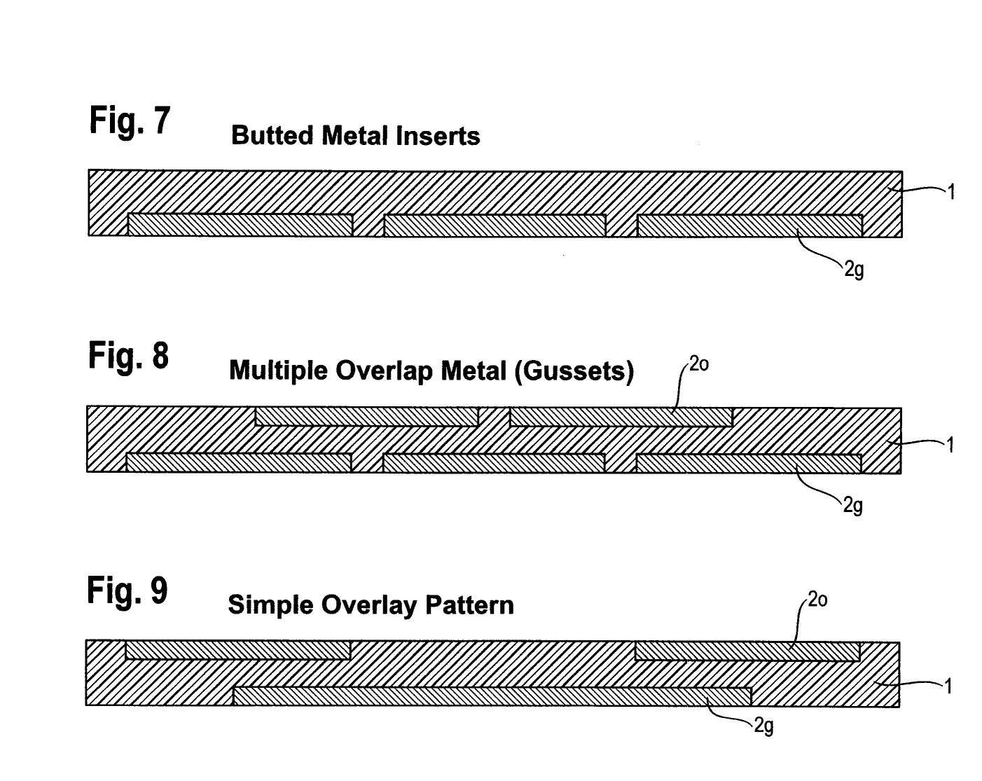

FIG. 7 a composite spacer strip material made of plastic and metal layers according to a seventh embodiment;

FIG. 8 a composite spacer strip material made of plastic and metal layers according to an eighth embodiment;

FIG. 9 a composite spacer strip material made of plastic and metal layers according to a ninth embodiment;

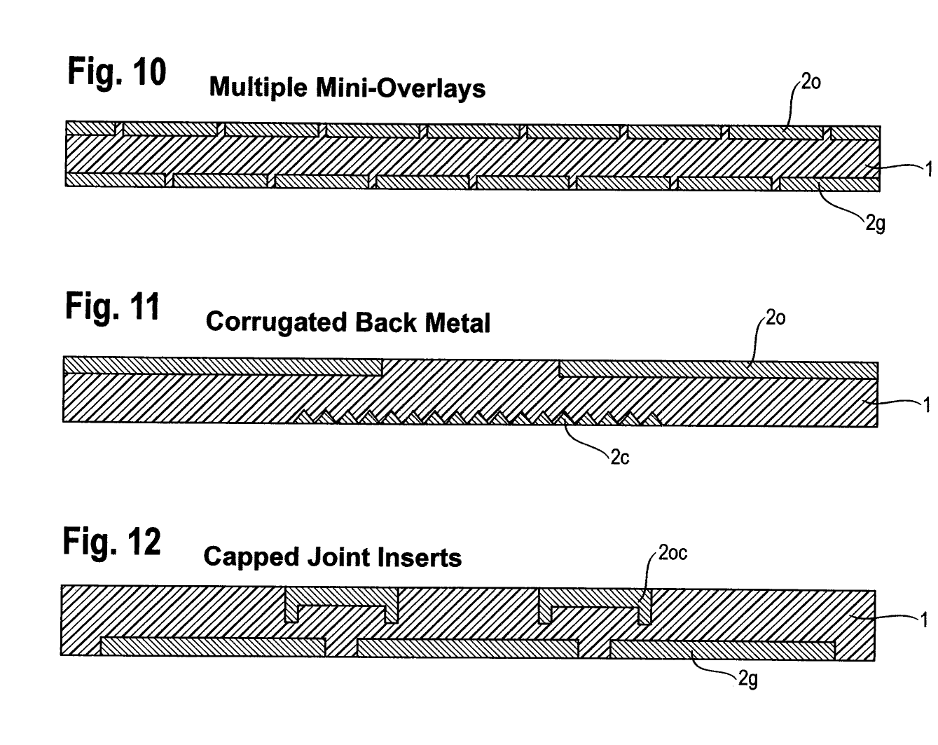

FIG. 10 a composite spacer strip material made of plastic and metal layers according to a tenth embodiment; wherein a second metal layer, which is also interrupted, overlaps the gaps in the first stainless steel layer;

FIG. 11 a composite spacer strip material made of plastic and metal layers and a corrugated metal layer according to an eleventh embodiment;

FIG. 12 a composite spacer strip material made of plastic and metal layers according to a twelfth embodiment, wherein a second metal layer, which is also interrupted, overlaps the gaps in the first stainless steel layer;

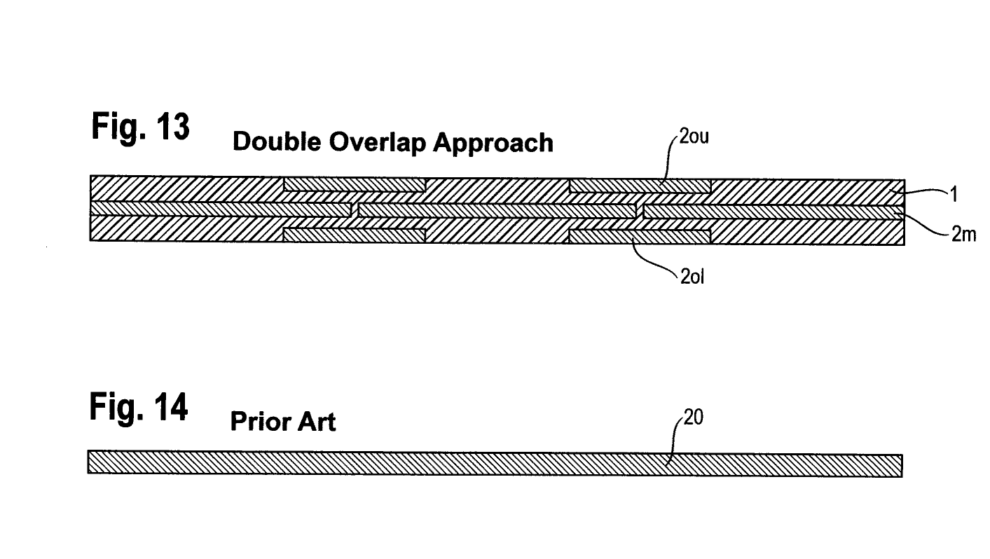

FIG. 13 a composite spacer strip material made of plastic and metal layers according to a thirteenth embodiment; and

FIG. 14 a spacer strip material made of a single metal layer according to the prior art.

In the following, preferred embodiments of the invention are described referring to the drawings.

FIG. 1 shows a cross sectional view perpendicular to the longitudinal direction (Z) of the composite spacer strip material according to a first embodiment of the invention, i.e. a cross section the width-thickness plane (Y-X plane). The composite spacer strip material consists of two layers, a first layer 1 made of plastic and a second or (reinforcement and/or barrier) layer 2 made of metal, preferably stainless steel. The composite spacer strip material consists of a combination of materials that are co-extruded, or extruded and/or laminated or bonded to form a low conductivity strip that can be coiled onto a spool. The co-extrusion process is preferred.

The plastic material is preferably an elastically-plastically deformable material (e.g., a plastic or resin material) having a relatively low heat conductivity. The metal layer is made of stainless steel, but could also be made of another deformable reinforcement material or layer, that is appropriated to be coupled to the elastically-plastically deformable material of layer one.

Preferred elastically-plastically deformable materials include synthetic or natural materials that undergo plastic, irreversible deformation after the elastic restoring forces of the bent material have been overcome. In such preferred materials, substantially no elastic restoring forces are active after deformation (bending) of the material beyond its apparent yielding point. Representative plastic materials also preferable exhibit a relatively low heat conductivity (i.e., preferred materials are heat-insulating materials), such as heat conductivities of less than about 5 W/(m*K), more preferably less than about 1 W/(m*K), and even more preferably less than about 0.3 W/(m*K). Particularly preferred materials for the profile body are thermoplastic synthetic materials including, but not limited to, polypropylene, polyethylene therephtalate, polyamide and/or polycarbonate. This plastic material(s) may also contain commonly used fillers (e.g., fibrous materials), additives, dyes, UV-protection agents, etc.

Preferred plastically deformable materials for the second layer(s) include metals that provide substantially no elastic restoring force after being bent beyond the apparent yielding point of the metal. Preferred materials for the profile body optionally exhibit a heat conduction value that is at least about 10 times less than the heat conduction value of the reinforcement material, more preferably about 50 times less than the heat conduction value of the reinforcement material and most preferably about 100 times less than the heat conduction value of the reinforcement material.

The first layer 1, i.e. preferably the plastic portion, of the composite spacer strip material, is permanently coupled (or materially connected) to the second layer(s) by the above manufacturing processes, preferably by co-extruding the first layer 1 with the second layer(s) 2 or laminating the same. The variety of further manufacturing techniques, which are not explicitly mentioned, may be utilized to make the material.

Preferably, the plastic material may comprise polypropylene Novolen 1040 K. An alternative is polypropylene MC208U comprising 20% talc, or polypropylene BA110CF, which is a heterophasic copolymer, both of which are available from Borealis A/S of Kongens Lyngby, Denmark. Alternatively, the plastic material may comprise Adstif® HA840K, which is a polypropylene homopolymer available from Basell Polyolefins Company NV.

The reinforcement material may be a metal foil or a thin metal plate material, e.g. AndralytE2, 8/2, 8T57 and may have a thickness of about 0.1 mm (approx. 4×10⁻³ Inch) The material of the second layer(s) 2 may be co-extruded with or laminated onto the first layer 1, for example, by adhering to the plastic portion using a 50 μm (approx. 2×10⁻³ Inch) layer of a bonding agent (adhesive) such a polyurethane and/or a polysulfide. Of course, if the second layer is made of a material subject to corrosion, the corresponding second layer may be treated to prevent corrosion. The material of the second layer(s) 2 is preferably stainless steel but can be also a tin-plated iron foil, such as a tin-plated iron foil having a chemical composition of: carbon 0.070%, manganese 0.400%, silicon 0.018%, aluminum 0.045%, phosphorus 0.020%, nitrogen 0.007%, the balance being iron. The tin layer having a weight/surface ratio of 2.8 g/m² and is applied to the base portion at a thickness at about 0.38 microns.

An example for a stainless steel foil is, e.g., Krupp Verdol Aluchrom I SE, having a thickness of about 0.05-0.2 mm (approx. 2×10⁻³-8×10⁻³ Inch), and most preferably about 0.1 mm (approx. 4×10⁻³ Inch). The chemical composition of this stainless steel may be approximately: chromium 19-21%, carbon maximum 0.03%, manganese maximum 0.50%, silicon maximum 0.60%, aluminum 4.7-5.5%, the balance being iron.

Alternatively, the material of the second layer(s) 2 may comprise aluminum metal having a thickness of about 0.2-0.4 mm (approx. 8×10⁻³-1.6×10⁻² Inch). Another alternative is a galvanized iron/steel sheet having a thickness of about 0.1-0.15 mm (approx. 4×10⁻³-6×10⁻³ Inch) as the material of the second layer(s) 2.

The above examples for the materials of the first layer 1 and the second layer(s) 2 are examples only. Favorable attributes of the materials are selected such that the strip material provides moisture transmission barrier properties and argon retention performance for the spacer to be used in a completed IG unit product.

A preferable composite spacer strip material has a thickness in the thickness direction (X) of about 0.010″ (2.54×10⁻⁴ m) such that the currently used roll-forming equipment for Intercept spacers can be used. Of course, it is possible to select other thicknesses and widths, depending on the desired spacer sizes and other properties. The width in the width direction (Y) can be varied significantly in a manufacturing process, in that, a wide sheet is fabricated (by extrusion, lamination or other means) and the wide sheet is subsequently slit into desired widths for forming into IG spacers. For example, the gross sheet would be about 60″ wide in the width direction (Y) and it would be slit into strips about 1.5″ wide.

In the examples shown in FIG. 1 to 13, the strip thickness in the thickness direction (X) is about 0.010″ (2.54×10⁻⁴ m) and the width in the width direction (Y) is about 1.5 inch (3.81×10⁻² m).

A second embodiment of the invention is shown in FIG. 2, where a plastic (first) layer 1 and a multi-layer tape (second layer) 3 are the components of the composite spacer strip material. The multi-layer tape can include plastic and/or metal materials.

A third embodiment of the composite spacer strip material is shown in FIG. 3, wherein a plastic (first) layer 1 and a curable matrix layer (second layer) 4 are provided.

FIG. 4 shows a fourth embodiment of the composite spacer strip material, wherein a corrugated metal (second) layer 2c is embedded in or on a plastic (first) layer 1.

FIG. 5 shows a fifth embodiment of the composite spacer strip material, wherein a plastic (first) layer 2 is embedded between a metal (second) layer 1 and a matrix (second) layer 5.

In all embodiments shown in FIGS. 1 to 5, the layers extend in planes parallel to the Y and Z direction, i.e. in planes parallel to the longitudinal direction of the composite spacer strip material (Z direction) and its width direction (Y direction). Preferably, the layers are stacked in the thickness direction (X direction).

FIG. 6 shows a sixth embodiment of the composite spacer strip material, wherein the second layer which is made preferably of metal, has a gap in its middle in the width direction. In other words, effectively two second layers 2g are provided with a gap of a predetermined width in the Y direction inbetween. The gap serves to provide a thermal break for the heat conductivity, as the material of the first layer 1 has a much lower heat conductivity than the material of the second layers 2g.

FIG. 7 shows a seventh embodiment, wherein three separated second layers 2g are provided, which are separated by predetermined gaps in the Y direction. In the seventh embodiment shown in FIG. 7, at the edges of the composite spacer strip material in the Y direction, the edges of the reinforcement layer 2g are embedded in the material of the first layer 1. However, it is also possible to have the edges of the second layers 2g forming the edges of the strip material in the Y direction as in FIG. 6.

FIG. 8 shows an eighth embodiment, wherein additionally to the plural second layers 2g provided on one side in the thickness direction X of the first layer 1, additional second layers 2o are provided such that they overlap, seen in the plane view in the X direction, the gaps provided between the second layers 2g in the Y direction. The number of second (overlap) layers corresponds to the number of gaps. Preferably, the overlap layers 2o are provided opposite to the second layers 2g, seen in the X direction.

FIG. 9 shows a ninth embodiment, showing a modification of the overlap configuration. One second layer 2g is provided on one side of the first layer 1 in the X direction such that there is a significant amount of (plastic) material of the first layer in the Y direction at both sides of the second layer 2g, and opposite to these areas in the X direction, two overlap reinforcement layers 2o are provided. These components are positioned such that when a shaped spacer is formed, the metal components are both bent and thus form an overlap at the corners of the U-shaped spacer.

FIG. 10 shows a tenth embodiment, showing a further modification of the overlap concept, wherein a plurality of second layers 2g and 2o are provided on both sides of the first layer 1 in the X direction, each overlapping a gap on the corresponding opposite side in the X direction.

FIG. 11 shows an eleventh embodiment, also showing a modification of the overlap concept, wherein one of the overlapping second layers is a corrugated second layer 2c corresponding to the corrugated second layer of the fourth embodiment.

FIG. 12 shows a twelfth embodiment, essentially corresponding to the eighth embodiment, wherein the second overlap layers 2oc are capped layers 2oc as shown in FIG. 12. That means, at the edges of the overlap layers 2oc in the Y direction, protrusions protruding in the X direction towards the opposite side of the first layer 1 are provided. It is also possible that the layers 2g have protrusions protruding in the X-direction towards the opposite side of the first layer 1.

FIG. 13 shows a thirteenth embodiment with a further modification of the overlap concept, namely a double overlap approach. Approximately in the middle of the first layer 1 in the Y direction, plural center (second) layers 2m are provided with gaps inbetween. On both sides in the Y direction of these gaps, overlap (second) layers 2ou and 2ol, i.e. overlap upper (second) layers and a overlap lower (second) layers 2ol are provided.

In all embodiments described above, the second layers can be reinforcement layers and/or barrier layers and made of the materials described with respect to the second layer(s) of the first embodiment, and the first layer 1 can be made of the same material as described with respect to the first embodiment.

All other descriptions of modifications and manufacturing processes also relate to all embodiments.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

1. A composite spacer strip material for manufacturing spacers for window units by rollforming the strip into a U-shaped spacer which composite spacer strip material is suitable to be coiled onto a spool, comprising:
a first layer made of an elastically-plastically deformable plastic or resin material; and
at least one second layer made of a plastically deformable material, which at least one second layer is materially connected to the first layer to form the composite spacer strip material;
which composite spacer strip material extends in a longitudinal direction (Z) having a cross section perpendicular to the longitudinal direction with a predetermined width in a width direction (Y) perpendicular to the longitudinal direction (Z) and a predetermined thickness in a thickness direction (X) perpendicular to the longitudinal and width directions;
wherein the first layer extends over the complete width in the width direction (Y); and
wherein the at least one second layer extends over at least a part of the width in the width direction.

2. The material according to claim 1, wherein the at least one second layer is fully or partly embedded in the material of the first layer.

3. The material according to claim 1, wherein at least two second layers are provided adjacent to each other in a plane extending in the longitudinal and width directions (Y, Z), with a predetermined gap in the width direction (Y) between the same.

4. The material according to claim 3, wherein at least a further second layer is provided, extending in a plane which is parallel to the longitudinal and width directions, and in a predetermined distance in the thickness direction from the at least two second layers such that, seen in the thickness direction, the further second layer overlaps the predetermined gap between the at least two second layers.

5. The material according to claim 1, wherein the plastically deformable material of the at least one second layer is a metal or curable matrix or a composite layer or a multi-layer material.

6. A coil of composite spacer strip material for manufacturing spacers for window units by rollforming the strip into a U-shaped spacer which composite spacer strip material coiled onto a spool, the composite spacer strip material comprising:
a first layer made of an elastically-plastically deformable plastic or resin material; and
at least one second layer made of a plastically deformable material, which at least one second layer is materially connected to the first layer to form the composite spacer strip material;
which composite spacer strip material extends in a strip direction and has a cross section perpendicular to the strip direction with a predetermined width in a width direction (Y) perpendicular to the strip direction (Z) and a predetermined thickness in a thickness direction (X) perpendicular to the strip and width directions;
wherein the first layer extends over the complete width in the width direction (Y); and
wherein the at least one second layer extends over at least a part of the width in the width direction.

7. The material according to claim 6, wherein the at least one second layer is fully or partly embedded in the material of the first layer.

8. The material according to claim 6, wherein at least two second layers are provided adjacent to each other in a plane extending in the longitudinal and width directions (Y, Z), with a predetermined gap in the width direction (Y) between the same.

9. The material according to claim 8, wherein at least a further second layer is provided, extending in a plane which is parallel to the longitudinal and width directions, and in a predetermined distance in the thickness direction from the at least two second layers such that, seen in the thickness direction, the further second layer overlaps the predetermined gap between the at least two second layers.

10. The material according to claim 6, wherein the plastically deformable material of the at least one second layer is a metal or curable matrix or a composite layer or a multi-layer material.
